(19) United States
(12) Patent Application Publication
(10) Pub. No.: US 2025/0300677 A1
(43) Pub. Date: Sep. 25, 2025

(54) FRONT-END ARCHITECTURE FOR SIMULTANEOUS TRANSMIT AND RECEIVE OPERATION

(71) Applicant: Skyworks Solutions, Inc., Irvine, CA (US)

(72) Inventors: Grant Darcy Poulin, Carp (CA); Jose Mari Elizalde Harrison, Newburyport, MA (US)

(21) Appl. No.: 19/052,827

(22) Filed: Feb. 13, 2025

Related U.S. Application Data
(60) Provisional application No. 63/567,130, filed on Mar. 19, 2024.

(51) Int. Cl. H04B 1/00; H04W 84/12; H04W 88/08

(52) U.S. Cl. CPC H04B 1/0064; H04W 84/12; H04W 88/08

(57) ABSTRACT

Front-end architectures for simultaneous transmit and receive operation are provided herein. In certain embodiments, a front-end module includes a bandpass filter, an antenna terminal for connecting to an antenna, a power amplifier, a low noise amplifier, and a plurality of switches for controlling access of the power amplifier and the low noise amplifier to the antenna terminal. The switches are operable in a transmit mode in which the switches connect an input of the power amplifier to the bandpass filter and an output of the power amplifier to the antenna terminal, and a receive mode in which the switches connect the input of the low noise amplifier to the antenna terminal through the bandpass filter.

### CROSS-REFERENCE TO RELATED APPLICATIONS

This application claims the benefit of priority under 35 U.S.C. § 119 of U.S. Provisional Patent Application No. 63/567,130, filed Mar. 19, 2024 and titled “FRONT-END ARCHITECTURE FOR SIMULTANEOUS TRANSMIT AND RECEIVE OPERATION,” which is herein incorporated by reference in its entirety.

### BACKGROUND

### Field

Embodiments of the invention relate to electronic systems, and in particular, to radio frequency (RF) electronics.

### Description of the Related Technology

Power amplifiers are used in RF communication systems to amplify RF signals for transmission via antennas.

Examples of RF communication systems with one or more power amplifiers include, but are not limited to, mobile phones, tablets, base stations, access points, customer-premises equipment (CPE), laptops, and wearable electronics. For example, in wireless devices that communicate using a cellular standard, a wireless local area network (WLAN) standard (such as an 802.11 standard for Wi-Fi), and/or any other suitable communication standard, a power amplifier can be used for RF signal amplification. An RF signal can have a frequency in the range of about 30 kilohertz (kHz) to 300 gigahertz (GHz).

### SUMMARY

In certain embodiments, an access point for a Wi-Fi network is disclosed. The access point includes a first antenna and a first front end module including a first bandpass filter, a first plurality of switches, a first power amplifier, and a first low noise amplifier. The first plurality of switches are operable in a transmit mode in which the first plurality of switches connect an input of the first power amplifier to the first bandpass filter and an output of the first power amplifier to the first antenna, and in a receive mode in which the first plurality of switches connect an input of the first low noise amplifier to the first antenna through the first bandpass filter.

In some embodiments, the first plurality of switches includes a first multi-throw switch having a pole connected to the first antenna and a second multi-throw switch having a pole connected to the first bandpass filter. According to a number of embodiments, the output of the first power amplifier is connected to a first throw of the first multi-throw switch and the input of the first power amplifier is connected to a first throw of the second multi-throw switch. In accordance with several embodiments, the first front end module further includes a receive bypass path connected between a second throw of the first multi-throw switch and a second throw of the second multi-throw switch. According to various embodiments, the first plurality of switches further includes a third multi-throw switch having a pole connected to the first bandpass filter and a first throw connected to the input of the first low noise amplifier. In accordance with a number of embodiments, the access point further includes a transceiver configured to provide a radio frequency transmit signal to a first throw of the third multi-throw switch and to receive an amplified radio frequency receive signal from a second throw of the third multi-throw switch. According to several embodiments, the access points further includes a first ceramic filter connected between the first antenna and the pole of the first multi-throw switch.

In various embodiments, in the receive mode the first low noise amplifier connects to the first antenna without any intervening filters. According to a number of embodiments, the Wi-Fi frequency band is one of a Wi-Fi 5 GHz band or a W-Fi 6 GHz band.

In some embodiments, the access point further includes a second antenna and a second front end module including a second bandpass filter, a second plurality of switches, a second power amplifier, and a second low noise amplifier. The second plurality of switches are operable in a transmit mode in which the second plurality of switches connect an input of the second power amplifier to the second bandpass filter and an output of the second power amplifier to the second antenna, and in a receive mode in which the second plurality of switches connect an input of the second low noise amplifier to the second antenna through the second bandpass filter. According to a number of embodiments, the first bandpass filters a Wi-Fi 5 GHz band and the second bandpass filter filters a W-Fi 6 GHz band. In accordance with several embodiments, the first bandpass filter filters a low frequency range of a Wi-Fi 5 GHz band and the second bandpass filter filters a high frequency range of the Wi-Fi 5 GHz band.

In certain embodiments, a front-end module is disclosed. The front-end module includes a bandpass filter, an antenna terminal for connecting to an antenna, a power amplifier configured to amplify a radio frequency transmit signal, a low noise amplifier configured to amplify a radio frequency receive signal, and a plurality of switches operable in a transmit mode in which the plurality of switches connect an input of the power amplifier to the bandpass filter and an output of the power amplifier to the antenna terminal, and in a receive mode in which the plurality of switches connect an input of the low noise amplifier to the antenna terminal through the bandpass filter.

In various embodiments, the plurality of switches includes a first multi-throw switch having a pole connected to the antenna terminal and a second multi-throw switch having a pole connected to the bandpass filter. According to a number of embodiments, the output of the power amplifier is connected to a first throw of the first multi-throw switch and the input of the power amplifier is connected to a first throw of the second multi-throw switch. In accordance with several embodiments, the front-end module further includes a receive bypass path connected between a second throw of the first multi-throw switch and a second throw of the second multi-throw switch. According to some embodiments, the plurality of switches further includes a third multi-throw switch having a pole connected to the bandpass filter and a first throw connected to the input of the low noise amplifier.

In several embodiments, the bandpass filter filters one of a Wi-Fi 5 GHz band or a W-Fi 6 GHz band.

In a number of embodiments, in the receive mode the low noise amplifier connects to the antenna terminal without any intervening filters.

In certain embodiments, a method of radio frequency signal communication is disclosed. The method includes operating a first plurality of switches of a first front-end module in a transmit mode in which the first plurality of switches connect an input of a first power amplifier of the first front-end module to a first bandpass filter of the first front-end module and an output of the first power amplifier to a first antenna, amplifying a radio frequency transmit signal from a transceiver using the first power amplifier in the transmit mode, operating the first plurality of switches in a receive mode in which the first plurality of switches connect an input of a first low noise amplifier of the first front-end module to the first antenna through the first bandpass filter, and amplifying a radio frequency receive signal from the first antenna using the first low noise amplifier in the receive mode.

In various embodiments, the first plurality of switches includes a first multi-throw switch having a pole connected to the first antenna and a second multi-throw switch having a pole connected to the first bandpass filter. According to a number of embodiments, the output of the first power amplifier is connected to a first throw of the first multi-throw switch and the input of the first power amplifier is connected to a first throw of the second multi-throw switch. In accordance with several embodiments, the first front end module further includes a receive bypass path connected between a second throw of the first multi-throw switch and a second throw of the second multi-throw switch. According to some embodiments, the first plurality of switches further includes a third multi-throw switch having a pole connected to the first bandpass filter and a first throw connected to the input of the first low noise amplifier.

In some embodiments, the method further includes using the transceiver to provide a radio frequency transmit signal to a first throw of the third multi-throw switch and to receive an amplified radio frequency receive signal from a second throw of the third multi-throw switch. According to a number of embodiments, the method further includes a first ceramic filter connected between the first antenna and the pole of the first multi-throw switch.

In various embodiments, the method further includes filtering a Wi-Fi frequency band using the first bandpass filter. According to a number of embodiments, the Wi-Fi frequency band is one of a Wi-Fi 5 GHz band or a W-Fi 6 GHz band.

In several embodiments, in the receive mode the first low noise amplifier connects to the first antenna without any intervening filters.

In various embodiments, the method further includes a second antenna and a second front end module including a second bandpass filter, a second plurality of switches, a second power amplifier, and a second low noise amplifier, the second plurality of switches operable in a transmit mode in which the second plurality of switches connect an input of the second power amplifier to the second bandpass filter and an output of the second power amplifier to the second antenna, and in a receive mode in which the second plurality of switches connect an input of the second low noise amplifier to the second antenna through the second bandpass filter. According to a number of embodiments, the method further includes filtering a Wi-Fi 5 GHz band using the first bandpass filter and filtering a W-Fi 6 GHz band using the second bandpass filter. In accordance with several embodiments, the method further includes filtering a low frequency range of a Wi-Fi 5 GHz band using the first bandpass filter and filtering a high frequency range of the Wi-Fi 5 GHz band using the second bandpass filter.

### BRIEF DESCRIPTION OF THE DRAWINGS

Embodiments of this disclosure will now be described, by way of non-limiting example, with reference to the accompanying drawings.

FIG. 1 is a schematic diagram of one embodiment of a Wi-Fi network.

FIG. 2 is a schematic diagram of one example of frequency separation between Wi-Fi 5 GHz and Wi-Fi 6 GHz frequency bands.

FIG. 3A is a schematic diagram of one example of self-interference for a Wi-Fi access point simultaneously transmitting on a Wi-Fi 6 GHz frequency band and receiving on a Wi-Fi 5 GHz frequency band.

FIG. 3B is a schematic diagram of one example of self-interference for a Wi-Fi access point simultaneously receiving on a Wi-Fi 6 GHz frequency band and transmitting on a Wi-Fi 5 GHz frequency band.

FIG. 4A is a schematic diagram of a Wi-Fi access point according to one embodiment.

FIG. 4B is a schematic diagram of a Wi-Fi access point according to another embodiment.

FIG. 5A is a schematic diagram of a Wi-Fi access point according to another embodiment.

FIG. 5B is a schematic diagram of a Wi-Fi access point according to another embodiment.

### DETAILED DESCRIPTION OF CERTAIN EMBODIMENTS

The following detailed description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

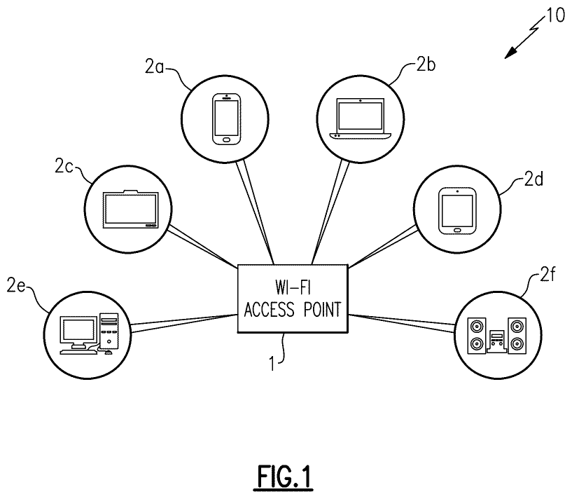

FIG. 1 is a schematic diagram of one embodiment of a Wi-Fi network 10. The Wi-Fi network 10 includes a Wi-Fi access point 1 and various examples of Wi-Fi enabled equipment, including a mobile phone 2a, a laptop 2b, a smart television 2c, a tablet 2d, a desktop computer 2e, and a smart audio system 2f.

Although specific examples of Wi-Fi enabled equipment are illustrated in FIG. 1, a Wi-Fi network can include Wi-Fi enabled equipment of other numbers and/or types. Thus, although various examples of Wi-Fi enabled equipment are shown, the teachings herein are applicable to a wide variety of types of equipment, including, but not limited to, mobile phones, tablets, laptops, IoT devices, wearable electronics, customer premises equipment (CPE), wireless-connected vehicles, wireless relays, and/or a wide variety of other communication devices. Furthermore, although one Wi-Fi access point is depicted, multiple Wi-Fi access points can be included in a Wi-Fi network.

The illustrated Wi-Fi network 10 of FIG. 1 supports communication over Wi-Fi 7 (IEEE 802.11be) as well as to subsequent Wi-Fi technologies such as Wi-Fi 8 and beyond.

Wi-Fi 7, also referred to as IEEE 802.11be or Extremely High Throughput (EHT) Wi-Fi, is a recent amendment of the IEEE 802.11 standard. Wi-Fi 7 is built upon 802.11ax and focuses on WLAN indoor and outdoor operation with stationary and pedestrian speeds. Wi-Fi 7 supports a number of frequency bands, including Wi-Fi 2.4 GHz, Wi-Fi 5 GHZ, and Wi-Fi 6 GHz.

The Wi-Fi 5 GHz frequency band spans from 5170 megahertz (MHz) to 5895 MHz and corresponds to Unlicensed National Information Infrastructure (UNII) frequency ranges 1, 2A, 2B, 3, and 4. Additionally, the Wi-Fi 6 GHz frequency band spans from 5945 MHz to 7125 MHz and corresponds to UNII frequency ranges 5, 6, 7, and 8. The UNII-4 frequency range operates from 5850 MHz to 5895 MHz, and was designated in 2021 by the Federal Communications Commission (FCC) for use as additional Wi-Fi spectrum in the US.

Various communication links of the Wi-Fi network 10 have been depicted in FIG. 1. The communication links can be duplexed in a wide variety of ways, including, for example, using time-division duplexing (TDD). TDD is a type of radio frequency communications that uses about the same frequency for transmitting and receiving signals, and in which transmit and receive communications are switched in time. TDD can provide efficient use of spectrum and variable allocation of throughput between transmit and receive directions.

Advanced feature support for Wi-Fi 7 and beyond specifies Wi-Fi access points (and in certain instances, Wi-Fi enabled equipment) to support simultaneous transmit and receive (STR) over two different Wi-Fi frequency bands.

Thus, as part of the Wi-Fi 7 standard (and future versions), all access points must support STR operation in at least two frequency bands. One desirable STR split is to use the Wi-Fi 5 GHz band (UNII-1 to UNII-4) for the first band and the Wi-Fi 6 GHz band (UNII-5 to UNII-8) as the second band.

Wi-Fi 7 supports complex modulation and coding schemes (MCS) that can be selected by the Wi-Fi access point 1 based on various parameters associated with the WiFi network 10. A given MCS can have different modulation type, coding rate, number of spatial streams, channel width, guard interval, and/or other properties. Table 1 below provides an example of MCS index, modulation type and coding rate for an example rate set for Wi-Fi 7 (IEEE 802.11be), in which certain indexes modulate using binary phase shift keying (BPSK), quadrature phase shift keying (QPSK), or quadrature amplitude modulation (QAM).

TABLE 1

| MCS | Modulation | Coding |
|---|---|---|
| Index | Type | Rate |
| MCS0 | BPSK | 1/2 |
| MCS1 | QPSK | 1/2 |
| MCS2 | QPSK | 3/4 |
| MCS3 | 16-QAM | 1/2 |
| MCS4 | 16-QAM | 3/4 |
| MCS5 | 64-QAM | 2/3 |
| MCS6 | 64-QAM | 3/4 |
| MCS7 | 64-QAM | 5/6 |
| MCS8 | 256-QAM | 3/4 |
| MCS9 | 256-QAM | 5/6 |
| MCS10 | 1024-QAM | 3/4 |
| MCS11 | 1024-QAM | 5/6 |
| MCS12 | 4096-QAM | 3/4 |
| MCS13 | 4096-QAM | 5/6 |

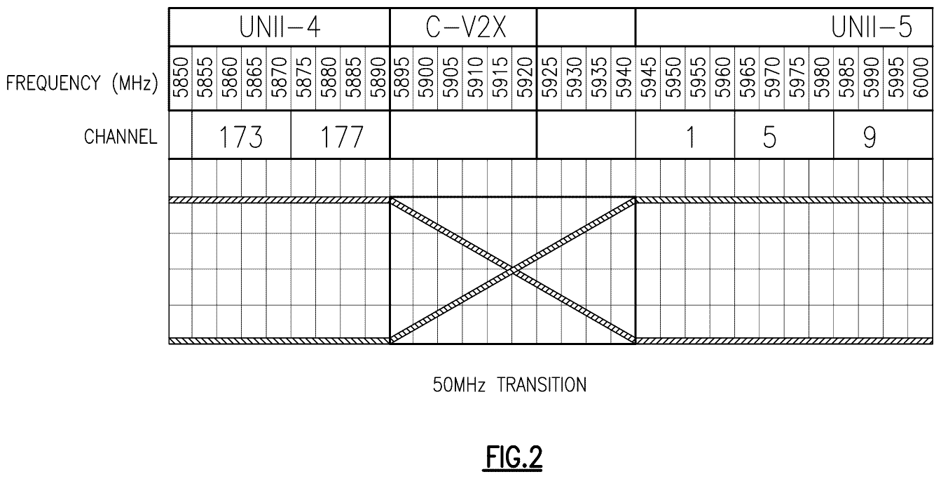

FIG. 2 is a schematic diagram of one example of frequency separation between Wi-Fi 5 GHz and Wi-Fi 6 GHz frequency bands. As depicted in FIG. 2, only a 50 MHz frequency spacing is present between the upper edge of the Wi-Fi 5 GHz frequency band (upper edge of UNII-4) and the bottom edge of the Wi-Fi 6 GHz frequency band (lower edge of UNII-5).

In view of the small 50 MHz frequency spacing, self-interference between the Wi-Fi 5 GHz band and the Wi-Fi 6 GHz band is a significant problem when these bands are used for STR operation.

For example, self-interference can arise from transmit noise from a Wi-Fi transmitter falling into the receive band of a co-located Wi-Fi receiver, resulting in a reduction of range and throughput.

To support STR operation, stringent filtering is desired for both the Wi-Fi 5 GHz band and the Wi-Fi 6 GHz band.

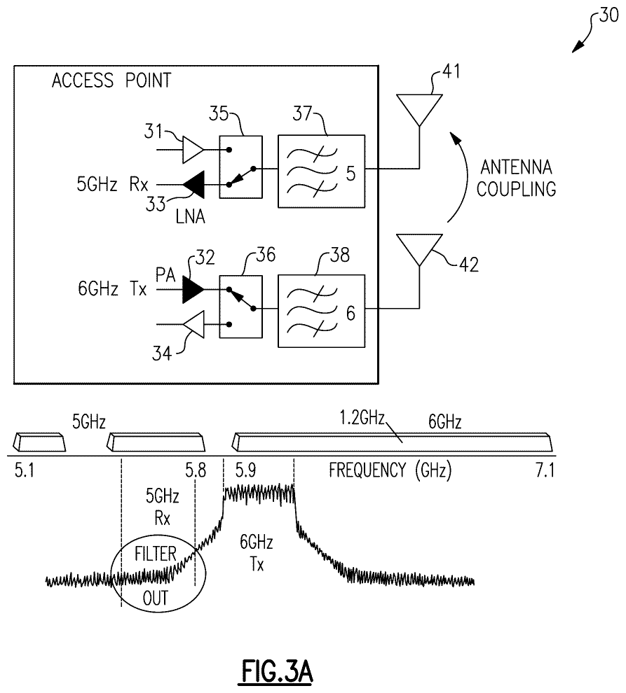

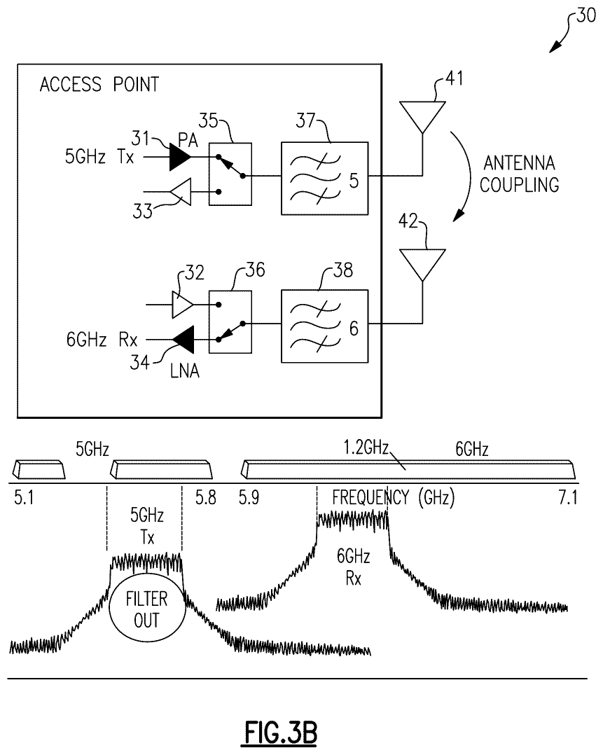

FIG. 3A is a schematic diagram of one example of self-interference for a Wi-Fi access point 30 simultaneously transmitting on a Wi-Fi 6 GHz frequency band and receiving on a Wi-Fi 5 GHz frequency band. FIG. 3B is a schematic diagram of one example of self-interference for the Wi-Fi access point 30 simultaneously receiving on a Wi-Fi 6 GHz frequency band and transmitting on a Wi-Fi 5 GHz frequency band.

With reference to FIGS. 3A and 3B, the Wi-Fi access point 30 includes a 5 GHz power amplifier (PA) 31, a 6 GHz power amplifier 32, a 5 GHz low noise amplifier (LNA) 33, a 6 GHz LNA 34, a 5 GHz transmit/receive (T/R) switch 35, a 6 GHz T/R switch 36, a 5 GHz band filter 37, a 6 GHz band filter 38, a 5 GHz antenna 41, and a 6 GHz antenna 42.

The 5 GHz band filter 37 reduces out of band (OOB) noise that would fall in the 6 GHz receive band, causing de-sensitization, and filters out the 6 GHz transmit signal that can degrade the linearity of the 5 GHz LNA 33.

In the example of FIG. 3A, the 6 GHz power amplifier 32 is transmitting while the 5 GHz LNA 33 is simultaneously receiving as part of STR operation for Wi-Fi 7. The 6 GHz band filter 38 is depicted as rejecting OOB noise from the 6 GHz transmit signal that degrades the noise floor and causes desensitization of the 5 GHz LNA 33.

The 5 GHz band filter 37 reduces the large 6 GHz OOB signal leakage that can otherwise saturate the 5 GHz LNA 33 and result in desensitization.

In the example of FIG. 3B, the 5 GHz power amplifier 31 is transmitting while the 6 GHz LNA 34 is simultaneously receiving as part of STR operation for Wi-Fi 7.

The 5 GHz band filter 37 is depicted as rejecting OOB noise from the 6 GHz transmit signal that degrades the noise floor and causes desensitization of the 5 GHz LNA 33.

The 6 GHz band filter 38 reduces the large 5 GHz OOB signal that can otherwise saturate the 6 GHz LNA 34 and result in desensitization.

In one example application, the 5 GHz band filter 37 is specified to pass a signal at 5895 MHz with less than 2 decibels (2 dB) of insertion loss while providing rejection of more than 70 dB at 5945 MHz, which is only 50 MHz away. In another application, the 6 GHz band filter 38 is specified to pass a signal at 5945 MHz with less than 2 dB of insertion loss.

### Examples of Front-End Architectures for Simultaneous Transmit and Receive Operation

It is desirable to have filters than can operate to allow simultaneous UNII-4/UNII-5 operation for STR. However, such filters are extremely challenging to fabricate given the 50 MHz band separation between the upper edge of UNII-4 and the lower edge of UNII-5. For example, achieving sufficient rejection with only a 50 MHz transition band over process and temperature may be infeasible for existing filter technology, such as surface acoustic wave (SAW) filters and/or bulk acoustic wave (BAW) filters.

Additionally, such filters are lossy, with typical insertion loss of 3 dB. On the transmit side, a post power amplifier filter results in loss of transmission range, reduced throughput, and/or increased power consumption. Furthermore, placing a filter after a power amplifier can also degrade the power amplifier's performance because of poor match. For example, it is difficult to design a wideband filter that has good return loss across the entire passband. When the filter presents a poor impedance match to the power amplifier, the linearity of the power amplifier and/or filter can be degraded. On the receive side, losses before the low noise amplifier degrade noise figure and thus also reduce range and throughput.

Front-end architectures for simultaneous transmit and receive operation are provided herein. In certain embodiments, a front-end module includes a bandpass filter, an antenna terminal for connecting to an antenna, a power amplifier, a low noise amplifier, and a plurality of switches for controlling access of the power amplifier and the low noise amplifier to the antenna terminal. The switches are operable in a transmit mode in which the switches connect an input of the power amplifier to the bandpass filter and an output of the power amplifier to the antenna terminal, and a receive mode in which the switches connect the input of the low noise amplifier to the antenna terminal through the bandpass filter.

By implementing the front-end module in this manner, losses after the power amplifier are reduced to improve performance. For example, by placing the bandpass filter on the small signal side (input side) of the power amplifier, the bandpass filter is easier to design since the bandpass filter need not handle high power levels associated with an amplified RF transmit signal outputted from a power amplifier. Furthermore, such a bandpass filter has low loss and/or a sharp transition band.

With respect to the transmit mode, the bandpass filter is placed at the input of the power amplifier and thus serves to reduce noise in the RF transmit signal from the transceiver that would otherwise get amplified by the power amplifier. With respect to the receive mode, the bandpass filter is provided at the input of the low noise amplifier to protect the low noise amplifier from large jammer signals, such as those arising from another frequency band (for example, an adjacent Wi-Fi band and/or nearby cellular bands). The bandpass filter also protects downstream components of a transceiver from large jammer signals.

In certain implementations, the switches include a first multi-throw switch having a pole connected to the antenna terminal and a second multi-throw switch having a pole connected to the bandpass filter. Additionally, the output of the power amplifier is connected to a first throw of the first multi-throw switch and the input of the power amplifier is connected to a first throw of the second multi-throw switch, while a receive bypass path is connected between a second throw of the first multi-throw switch and a second throw of the second multi-throw switch. Thus, the first and second multi-throw switches serve to connect the antenna terminal to either the output of the power amplifier in the transmit mode or to the receive bypass path in the receive mode.

In some implementations, the switches further include a third multi-throw switch. The third multi-throw switch includes a pole connected to the bandpass filter and a first throw connected to the input of the low noise amplifier and a second pole for receiving an RF transmit signal.

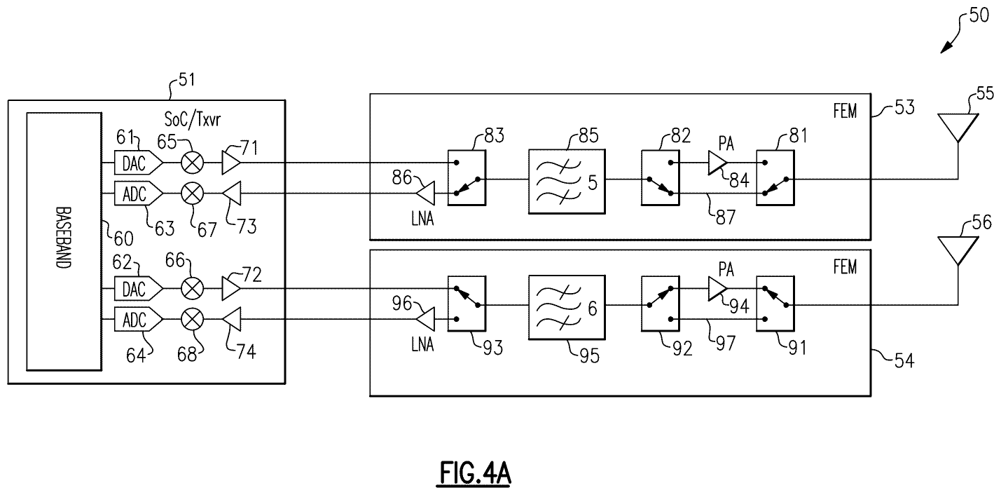

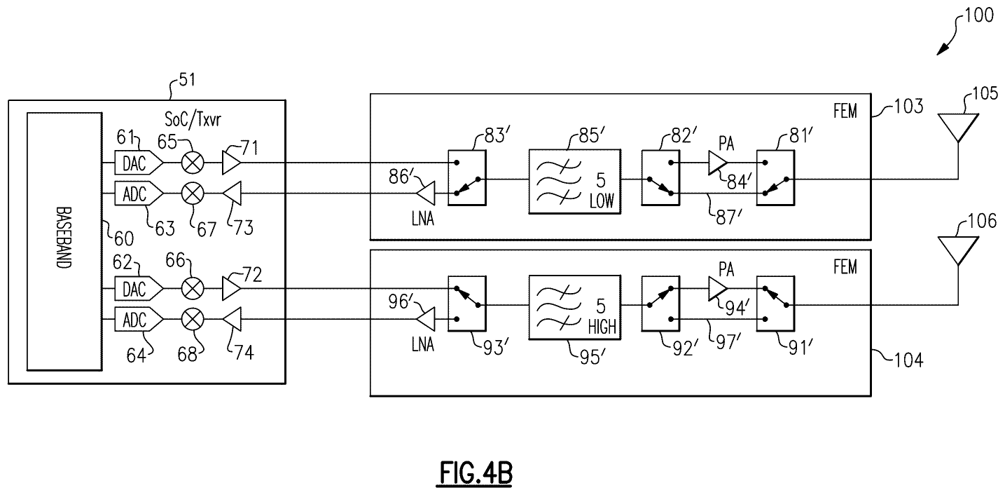

FIG. 4A is a schematic diagram of a Wi-Fi access point 50 according to one embodiment. The Wi-Fi access point 50 includes a transceiver 51 (for instance, a Wi-Fi system controller or SoC), a 5 GHz front-end module 53, a 6 GHz front-end module 54, a 5 GHz antenna 55, and a 6 GHz antenna 56.

In the illustrated embodiment, the transceiver 51 includes a baseband circuit 60, a 5 GHz transmit-path digital-to-analog converter (DAC) 61, a 6 GHz transmit-path DAC 62, a 5 GHz receive-path analog-to-digital converter (ADC) 63, a 6 GHz receive-path ADC 64, a 5 GHz transmit-path mixer 65, a 6 GHz transmit-path mixer 66, a 5 GHz receive-path mixer 67, a 6 GHz receive-path mixer 68, a 5 GHz transmit amplifier 71, a 6 GHz transmit amplifier 72, a 5 GHz receive amplifier 73, and a 6 GHz receive amplifier 74.

With continuing reference to FIG. 4A, the 5 GHz front-end module 53 includes a first multi-throw switch 81, a second multi-throw switch 82, a third multi-throw switch 83, a 5 GHz power amplifier 84, a 5 GHz band filter 85 (for instance, a BAW filter), and a 5 GHz LNA 86. Additionally, the 6 GHz front-end module 54 includes a first multi-throw switch 91, a second multi-throw switch 92, a third multi-throw switch 93, a 6 GHz power amplifier 94, a 6 GHz band filter 95 (for instance, a BAW filter), and a 6 GHz LNA 96.

As shown in FIG. 4A, a pole of the first multi-throw switch 81 is connected to the 5 GHz antenna 55, while a first throw of the first multi-throw switch 81 is connected to an output of the 5 GHz power amplifier 84. Additionally, a pole of the second multi-throw switch 82 is connected to a first terminal of the 5 GHz band filter 85, while a first throw of the second multi-throw switch 82 is connected to an input of the 5 GHz power amplifier 84. A 5 GHz receive bypass path 87 is connected between a second throw of the first multi-throw switch 81 and a second throw of the second multi-throw switch 82. A pole of the third multi-throw switch 83 is connected to a second terminal of the 5 GHz band filter 85, while a first throw of the third multi-throw switch 83 receives a 5 GHz transmit signal from the transceiver 51. An input of the 5 GHz LNA 86 is connected to a second throw of the third multi-throw switch 83, while an output of the 5 GHz LNA 86 provides a 5 GHz receive signal to the transceiver 51.

In the illustrated embodiment, a pole of the first multi-throw switch 91 is connected to the 6 GHz antenna 56, while a first throw of the first multi-throw switch 91 is connected to an output of the 6 GHz power amplifier 94. Additionally, a pole of the second multi-throw switch 92 is connected to a first terminal of the 6 GHz band filter 95, while a first throw of the second multi-throw switch 92 is connected to an input of the 6 GHz power amplifier 94. A 6 GHz receive bypass path 97 is connected between a second throw of the first multi-throw switch 91 and a second throw of the second multi-throw switch 92. A pole of the third multi-throw switch 93 is connected to a second terminal of the 6 GHz band filter 95, while a first throw of the third multi-throw switch 93 receives a 6 GHz transmit signal from the transceiver 51. An input of the 6 GHz LNA 96 is connected to a second throw of the third multi-throw switch 93, while an output of the 6 GHz LNA 96 provides a 6 GHz receive signal to the transceiver 51.

The 5 GHz front-end module 53 is operable in a transmit mode or a receive mode. In the transmit mode, the switches 81/82 connect an input of the 5 GHz power amplifier 84 to the 5 GHz band filter 85 and an output of the 5 GHz power amplifier 84 to the 5 GHz antenna 55. Additionally, in the transmit mode, the switch 83 provides the 5 GHz transmit signal to the 5 GHz band filter 85. In the receive mode, the switches 81-83 connect an input of the 5 GHz LNA 86 to the 5 GHz antenna 55 through the 5 GHz band filter 85.

The 6 GHz front-end module 54 is also operable in a transmit mode or a receive mode, which can be independently controlled from the transmit mode and the receive mode of the 5 GHz front-end module 53. In the transmit mode of the 6 GHz front-end module 54, the switches 91/92 connect an input of the 6 GHz power amplifier 94 to the 6 GHz band filter 95 and an output of the 6 GHz power amplifier 94 to the 6 GHz antenna 56. Additionally, in the transmit mode, the switch 93 provides the 6 GHz transmit signal to the 6 GHz band filter 95. In the receive mode of the 6 GHz front-end module 54, the switches 91-93 connect an input of the 6 GHz LNA 96 to the 6 GHz antenna 56 through the 6 GHz band filter 95.

The illustrated embodiment does not include post power amplifier filters to reduce losses after the power amplifiers 84/94 to improve performance. Furthermore, by placing the bandpass filters 85/95 on the input side of the power amplifiers 84/94 during transmit, the bandpass filters 85/95 can be designed with smaller size, lower loss, and/or sharper transition band. Moreover, placing the bandpass filters 85/95 on the input side of the power amplifiers 84/94 during transmit has the added benefit of reducing any transmit signal noise from the transceiver 51 that would otherwise get amplified by the power amplifiers 84/94.

With respect to receive, the bandpass filters 85/95 protect the LNAs 86/96 from large jammer signals both from the adjacent Wi-Fi band (for example, a jammer from the 6 GHz power amplifier 94 reaching the 5 GHz LNA 86 or a jammer from the 5 GHz power amplifier 84 reaching the 6 GHz LNA 96 during STR) as well as from nearby cellular bands. The bandpass filters 85/95 also protect the transceiver 51 from such jammer signals.

In the illustrated embodiment, during the transmit modes the power amplifiers 84/94 provide amplified transmit signals to the antennas 55/56 without any post power amplifier filtering. By removing filtering after the power amplifiers 84/94, OOB noise is no longer attenuated and any OOB noise that couples from the transmitter of one band to the receiver of the other band will degrade the receiver's performance.

To mitigate OOB noise, one or more approaches can be taken.

In a first example, without reducing the power amplifier's saturated output power, the transmit power of the power amplifier can be reduced by backing the power amplifier off farther from the power amplifier's saturated output power. By backing the power amplifier off in this manner, OOB noise is significantly reduced. Although operating at a lower transmit power will reduce the transmit range, but this is at least partially compensated for by the reduction in post power amplifier losses arising from removing filtering after the power amplifiers 84/94.

In a second example, the saturated output power (Psat) of the power amplifier is increased. By running a power amplifier backed off farther from Psat, OOB noise will be reduced.

In a third example, antenna isolation is used to mitigate OOB noise. For instance, with careful antenna design, antenna isolation of 40 dB or more can be achieved for the antennas 55/56. This improves both transmit OOB noise (since less OOB power is coupled into the victim receiver) and receive saturation (since less transmit power is coupled to the receiver).

FIG. 4B is a schematic diagram of a Wi-Fi access point 100 according to another embodiment. The Wi-Fi access point 100 includes a transceiver 51, a low 5 GHz front-end module 103, a high 5 GHz front-end module 104, a low 5 GHz antenna 105, and a high 5 GHz antenna 106.

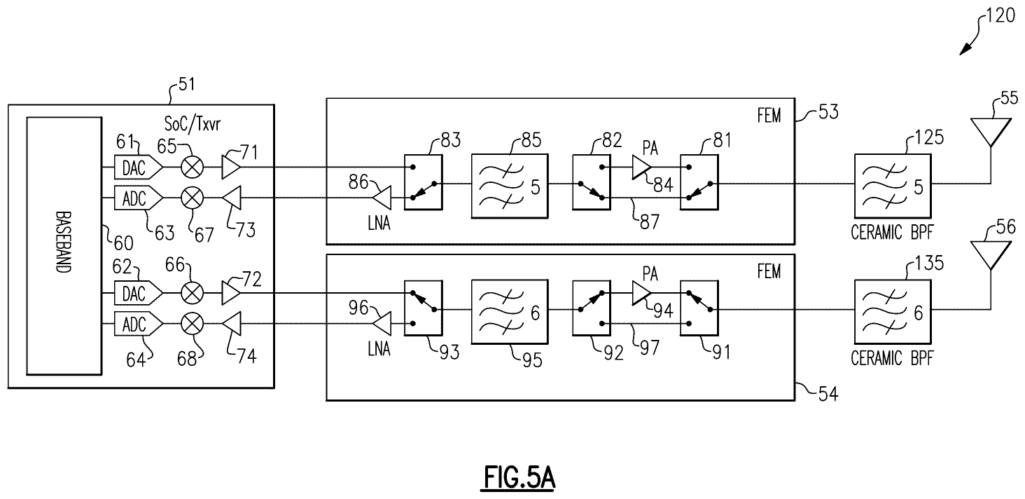

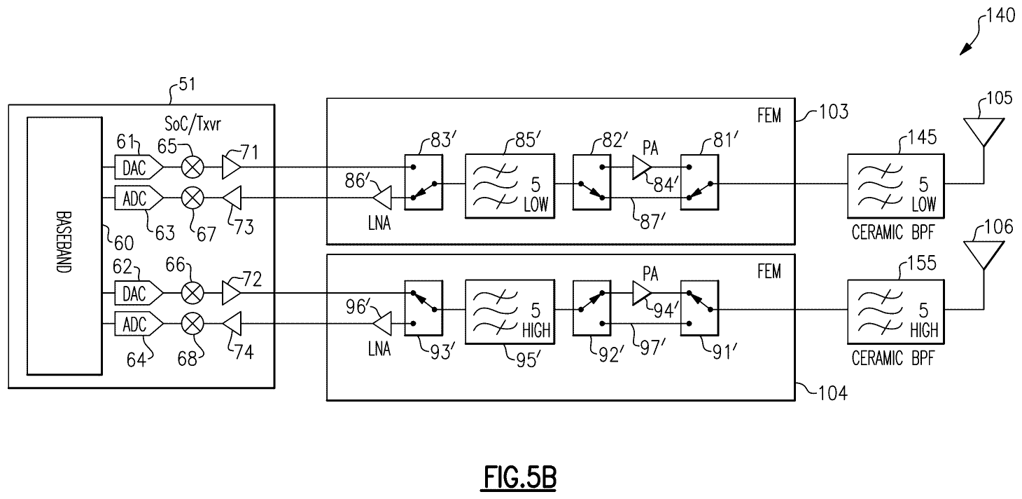

The Wi-Fi access point 100 of FIG. 4B is similar to the Wi-Fi access point 50 of FIG. 4A, except that the Wi-Fi access point 100 includes the low 5 GHz front-end module 103 and the low 5 GHz antenna 105 for operating over a low frequency range of 5 GHz Wi-Fi and the high 5 GHz front-end module 104 and the high 5 GHz antenna 106 for operating over a high frequency range of 5 GHz Wi-Fi. Thus, rather than operating over 5 GHz Wi-Fi and 6 GHz Wi-Fi like the Wi-Fi access point 50 of FIG. 4A, the Wi-Fi access point 100 of FIG. 5B operates over two different frequency ranges of 5 GHz Wi-Fi.

As shown in FIG. 4A, the low 5 GHz front-end module 103 includes a first multi-throw switch 81′, a second multi-throw switch 82′, a third multi-throw switch 83′, a low 5 GHz power amplifier 84′, a low 5 GHz band filter 85′, and a low 5 GHz LNA 86′. Additionally, the high 5 GHz front-end module 104 includes a first multi-throw switch 91′, a second multi-throw switch 92′, a third multi-throw switch 93′, a high 5 GHz power amplifier 94′, a high 5 GHz band filter 95′, and a high 5 GHz LNA 96′.

The Wi-Fi access point 100 of FIG. 4B is suitable for a wide variety of applications, including countries and/or regions in which the 6 GHz Wi-Fi frequency band is not supported.

FIG. 5A is a schematic diagram of a Wi-Fi access point 120 according to another embodiment. The Wi-Fi access point 120 includes a transceiver 51, a 5 GHz front-end module 53, a 6 GHz front-end module 54, a 5 GHz antenna 55, a 6 GHz antenna 56, a 5 GHz ceramic bandpass filter 125, and a 6 GHz ceramic bandpass filter 135.

The Wi-Fi access point 120 of FIG. 5A is similar to the Wi-Fi access point 50 of FIG. 4A, except that the Wi-Fi access point 120 of FIG. 5A further includes the 5 GHz ceramic bandpass filter 125 and the 6 GHz ceramic bandpass filter 135.

By including the 5 GHz ceramic bandpass filter 125 and the 6 GHz ceramic bandpass filter 135, power amplifier OOB noise is reduced at the cost of additional components and an increase in power amplifier loss.

In certain implementations, the 5 GHz front-end module 53, the 6 GHz front-end module 54, the 5 GHz ceramic bandpass filter 125 and the 6 GHz ceramic bandpass filter 135 are all attached to a common circuit board.

FIG. 5B is a schematic diagram of a Wi-Fi access point 140 according to another embodiment. The Wi-Fi access point 140 includes a transceiver 51, a low 5 GHz front-end module 103, a high 6 GHz front-end module 104, a low 5 GHz antenna 105, a high 5 GHz antenna 106, a low 5 GHz ceramic bandpass filter 145, and a high 5 GHz ceramic bandpass filter 155.

The Wi-Fi access point 140 of FIG. 5B is similar to the Wi-Fi access point 100 of FIG. 4B, except that the Wi-Fi access point 140 of FIG. 5B further includes the low 5 GHz ceramic bandpass filter 145 and the high 5 GHz ceramic bandpass filter 155 for reducing OOB noise.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “may,” “could,” “might,” “can,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While certain embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

1. An access point for a Wi-Fi network, the access point comprising:
a first antenna; and
a first front end module including a first bandpass filter, a first plurality of switches, a first power amplifier, and a first low noise amplifier, the first plurality of switches operable in a transmit mode in which the first plurality of switches connect an input of the first power amplifier to the first bandpass filter and an output of the first power amplifier to the first antenna, and in a receive mode in which the first plurality of switches connect an input of the first low noise amplifier to the first antenna through the first bandpass filter.

2. The access point of claim 1 wherein the first plurality of switches includes a first multi-throw switch having a pole connected to the first antenna and a second multi-throw switch having a pole connected to the first bandpass filter.

3. The access point of claim 2 wherein the output of the first power amplifier is connected to a first throw of the first multi-throw switch and the input of the first power amplifier is connected to a first throw of the second multi-throw switch.

4. The access point of claim 3 wherein the first front end module further includes a receive bypass path connected between a second throw of the first multi-throw switch and a second throw of the second multi-throw switch.

5. The access point of claim 2 wherein the first plurality of switches further includes a third multi-throw switch having a pole connected to the first bandpass filter and a first throw connected to the input of the first low noise amplifier.

6. The access point of claim 5 further comprising a transceiver configured to provide a radio frequency transmit signal to a first throw of the third multi-throw switch and to receive an amplified radio frequency receive signal from a second throw of the third multi-throw switch.

7. The access point of claim 2 further comprising a first ceramic filter connected between the first antenna and the pole of the first multi-throw switch.

8. The access point of claim 1 wherein in the receive mode the first low noise amplifier connects to the first antenna without any intervening filters.

9. The access point of claim 8 wherein the Wi-Fi frequency band is one of a Wi-Fi 5 GHz band or a W-Fi 6 GHz band.

10. The access point of claim 1 further comprising a second antenna and a second front end module including a second bandpass filter, a second plurality of switches, a second power amplifier, and a second low noise amplifier, the second plurality of switches operable in a transmit mode in which the second plurality of switches connect an input of the second power amplifier to the second bandpass filter and an output of the second power amplifier to the second antenna, and in a receive mode in which the second plurality of switches connect an input of the second low noise amplifier to the second antenna through the second bandpass filter.

11. The access point of claim 10 wherein the first bandpass filters a Wi-Fi 5 GHz band and the second bandpass filter filters a W-Fi 6 GHz band.

12. The access point of claim 10 wherein the first bandpass filter filters a low frequency range of a Wi-Fi 5 GHz band and the second bandpass filter filters a high frequency range of the Wi-Fi 5 GHz band.

13. A front-end module comprising:
a bandpass filter;
an antenna terminal for connecting to an antenna;
a power amplifier configured to amplify a radio frequency transmit signal;
a low noise amplifier configured to amplify a radio frequency receive signal; and
a plurality of switches operable in a transmit mode in which the plurality of switches connect an input of the power amplifier to the bandpass filter and an output of the power amplifier to the antenna terminal, and in a receive mode in which the plurality of switches connect an input of the low noise amplifier to the antenna terminal through the bandpass filter.

14. The front-end module of claim 13 wherein the plurality of switches includes a first multi-throw switch having a pole connected to the antenna terminal and a second multi-throw switch having a pole connected to the bandpass filter.

15. The front-end module of claim 14 wherein the output of the power amplifier is connected to a first throw of the first multi-throw switch and the input of the power amplifier is connected to a first throw of the second multi-throw switch.

16. The front-end module of claim 15 further comprising a receive bypass path connected between a second throw of the first multi-throw switch and a second throw of the second multi-throw switch.

17. The front-end module of claim 14 wherein the plurality of switches further includes a third multi-throw switch having a pole connected to the bandpass filter and a first throw connected to the input of the low noise amplifier.

18. The front-end module of claim 13 wherein the bandpass filter filters one of a Wi-Fi 5 GHz band or a W-Fi 6 GHz band.

19. The front-end module of claim 13 wherein in the receive mode the low noise amplifier connects to the antenna terminal without any intervening filters.

20. A method of radio frequency signal communication, the method comprising:
operating a first plurality of switches of a first front-end module in a transmit mode in which the first plurality of switches connect an input of a first power amplifier of the first front-end module to a first bandpass filter of the first front-end module and an output of the first power amplifier to a first antenna;
amplifying a radio frequency transmit signal from a transceiver using the first power amplifier in the transmit mode;
operating the first plurality of switches in a receive mode in which the first plurality of switches connect an input of a first low noise amplifier of the first front-end module to the first antenna through the first bandpass filter; and
amplifying a radio frequency receive signal from the first antenna using the first low noise amplifier in the receive mode.

21.-32. (canceled)
